(19) United States
(12) Patent Application Publication
(10) Pub. No.: US 2020/0401438 A1
(43) Pub. Date: Dec. 24, 2020

(54) MASTER-VIRTUAL MACHINE FRAMEWORK

(71) Applicant: Ananda Kammampati, Fremont, CA (US)

(72) Inventor: ANANDA KUMAR KAMMAMPATI, FREMONT, CA (US)

(21) Appl. No.: 16/946,753

(22) Filed: Jul. 5, 2020

Related U.S. Application Data
(63) Continuation of application No. 15/810,034, filed on Nov. 11, 2017, now abandoned.
(60) Provisional application No. 62/421,347, filed on Nov. 13, 2016.

(51) Int. Cl. G06F 9/455; G06F 9/48; G06F 9/50; G06F 8/61

(52) U.S. Cl. CPC G06F 9/45558; G06F 9/4843; G06F 9/5077; G06F 9/50; G06F 2009/45595; G06F 2009/45562; G06F 8/61

(57) ABSTRACT

A “Master-Virtual Machine (VM) framework” is provided that contains a Master-VM, which is a custom built VM for learning about a specified technology, service or product, and an optional host server device that is a custom built portable physical server. The Master-VM framework enables a user to use a single virtual machine (“Master-VM”) from an online source to set up a hands-on lab for learning about a specified application. For example, the user can use the Master-VM to set up a hands-on lab to learn about Hadoop technology. The hands-on lab can include a collection of VMs associated with Hadoop technology framework and various training materials such as documentations, training videos, lab exercises associated with Hadoop technology. The Master-VM can deploy the collection of VMs associated and allow the user to access, explore, evaluate or configure the Hadoop technology framework using the multiple VMs and the training materials.

### CROSS-REFERENCE TO RELATED APPLICATION(S)

This application is a continuation of U.S. patent application Ser. No. 15/810,034 filed on Nov. 11, 2017, entitled “MASTER-VIRTUAL MACHINE FRAMEWORK”, which claims the benefit of U.S. Provisional Application Ser. No. 62/421,347 titled “MASTER-VM FRAMEWORK” filed Nov. 13, 2016, both of which are incorporated herein by reference for all purposes in their entirety.

### BACKGROUND

The pace, trend at which so many compelling (and complex) technologies in the Information Technology (IT) industry are springing up in the market and moving at rapid speed, it is becoming increasing challenging in not only to learn them in a faster pace, it is equally challenging to spread that knowledge and required skills across locally and globally to meet the industry demands. At any point in time, the IT industry is always on the lookout for capable professionals with solid foundations, irrespective of where they are located. While the theory aspect of any IT can be learnt from many avenues, such as books, online courses, and/or videos online, the real challenge in getting a true hands-on experience still remain at large.

At present, there is no single model or a universal framework as such that can provide a systematic guidance in transferring technical hands-on knowledge globally across to the masses in a consistent manner. An unified approach in which individuals, teams can get trained on a same level field and with the same level of quality irrespective of where they reside, is still missing.

Some of the popular methods that are currently available to address these challenges include: 1) In-person Instructor-led training, 2) Online Instructor-led training, 3) Hands-On labs/Self-paced labs, 4) Learning from online training web sites, and 5) Self-taught from YouTube videos.

An in-person instructor-led training will normally be conducted for a few days (depending on the length of course) and can be very effective since it is a face-to-face training. The disadvantages of such a training method includes (a) cost, which can be significantly high, (b) a limited class size, which may need individuals to plan either well in advance to get trained or have to wait for class availability, (c) geography/location—not all instructors-led classes will be available in all the cities all the time, which might need individuals to travel, and (d) Limited availability of time with Lab exercises—the duration for the availability of labs for hands-on training can be limited.

An online instructor-led training can overcome some of the challenges that are faced with in-person Instructor-led training namely with respect to cost and location, but when it comes to hands-on labs and lab exercises, it still faces the same challenges as mentioned above.

In hands-on labs mode of training, individuals can sign into a website portal, select the desired hands-on lab from the Catalog, power it on and learn that specific product or a technology provided by that hands-on lab by following the instructions that come along. The disadvantages of such a training method includes (a) huge capital & operational costs, as a significant number of system administrators, infrastructure architects, solution architects have to work behind the scene, (b) noisy neighborhood problems—one set of individuals can take away most of the computer resources when doing their hands-on lab exercises online while preventing others to do their lab exercises at the same time because of the heavy workload and resource constraints on the shared physical infrastructure, (c) challenges with latency, as it is still possible for individuals to run into bottlenecks and delays because of network latencies, (d) one size may not fit all—hands-on labs are built with the expectation that specific sets of skillsets are met as pre-requisites and this gets challenging because though some might be interested in learning from a specific hands-on lab, they may not understand fully in-depth because of their own lack of exposure to the pre-requisites, and they may not find another hands-on lab that teaches them exclusively on the pre-requisites.

In self-taught or do-it-yourself videos, which can be the most predominant and popular way of learning anything, the disadvantages may include (a) an information overload, as there are so many videos and there are so many ways to do the same thing, and it's easy to get lost in what one is looking for, (b) time—one needs a lot of time at their disposal to watch many videos, pick up the good ones or good portions of many videos and make sense of them all, and the learning could end up being a laborious process in by itself.

### BRIEF DESCRIPTION OF THE DRAWINGS

FIG. 1 is a block diagram of the environment in which the disclosed embodiments can be implemented.

FIG. 2 is a flow diagram of a process for creating a Master-VM for a hands-on lab of a specified application, consistent with various embodiments.

FIG. 3 is a flow diagram of a process for creating lab exercises for a hands-on lab of a specified application, consistent with various embodiments.

FIG. 4 is a flow diagram of a process for creating video lessons for a hands-on lab of a specified application, consistent with various embodiments.

FIG. 5 is a flow diagram of a process for configuring a client device to install a Master-VM, consistent with various embodiments. In some embodiments, the process can be implemented in the environment of FIG. 1.

FIG. 6 is a flow diagram of a process for installing a Master-VM at a client device, consistent with various embodiments.

FIG. 7A is an example screenshot of a homepage of the Master-VM, consistent with various embodiments.

FIG. 7B is another example screenshot of a homepage of the Master-VM, consistent with various embodiments.

FIG. 8 is a block diagram of the environment in which the disclosed embodiments can be implemented.

FIG. 9 is a block diagram of a computer system as may be used to implement features of the disclosed embodiments.

FIG. 10 is a block diagram of a computing system for implementing the host server device of FIG. 1, consistent with various embodiments.

### DETAILED DESCRIPTION

Embodiments are disclosed for a virtual machine (VM) framework that employs a single VM that can further provision multiple VMs of an application on a host server device to enable a user to access, evaluate, explore and/or configure the application. The VM framework enables a user to download a single virtual machine (“Master-VM”) from an online source and use it to set up an hands-on lab for learning about a specified application, e.g., a technology of their choice. For example, the user can use the Master-VM to set up an hands-on lab to learn about Hadoop technology. The hands-on lab can include a collection of VMs for deploying Hadoop technology framework, and various training materials such as documentations, training videos, lab exercises associated with Hadoop technology. The Master-VM can deploy the collection of VMs associated with the Hadoop hands-on lab on a host server device, provide the training materials, and allow the user to access, explore, evaluate or configure the Hadoop technology framework using the multiple VMs and the training materials. The VM framework can facilitate creation of hands-on labs for various such applications, hence referred to as “Master-VM framework.” The Master-VM framework enables the user to train on technology of their choice in their own pace, in their own time and on their own host server device.

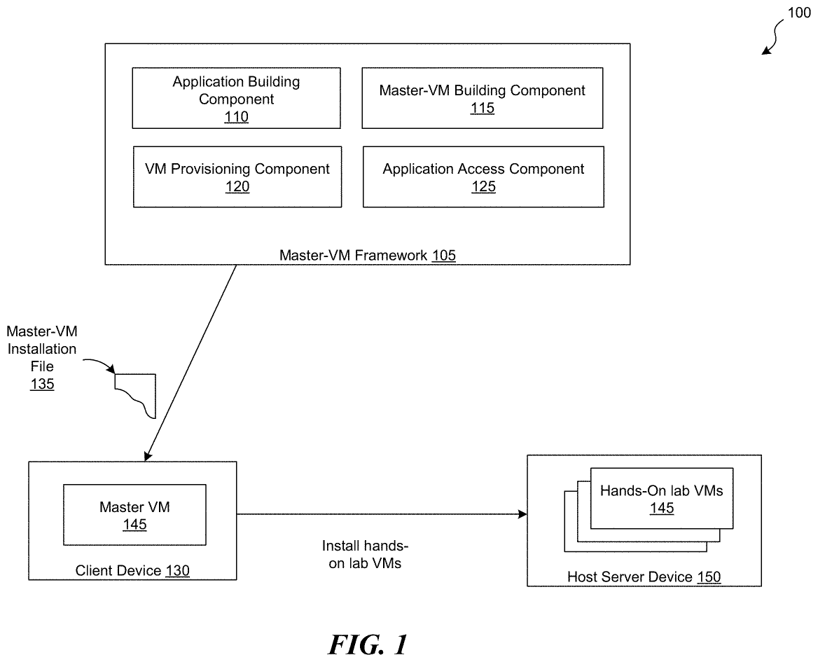

Turning now to Figures, FIG. 1 is a block diagram of the environment in which the disclosed embodiments can be implemented. The Master-VM framework 105 includes (a) an application building component 110, (b) a master-VM building component 115, (c) a VM provisioning component 120 and (d) an application access component 125. The Master-VM framework 105 can be implemented as a distributed framework in which the components of the Master-VM framework 105 are distributed across multiple computer systems. For example, the application building component 110 and a master-VM building component 115 can be implemented at a first computing system (not illustrated), and the VM provisioning component 120 can be implemented at a client device 130, and (d) the application access component 125 at the client device 130 and a host server device 150. In some embodiments, a single component of the Master-VM framework 105 may be implemented at multiple computer systems.

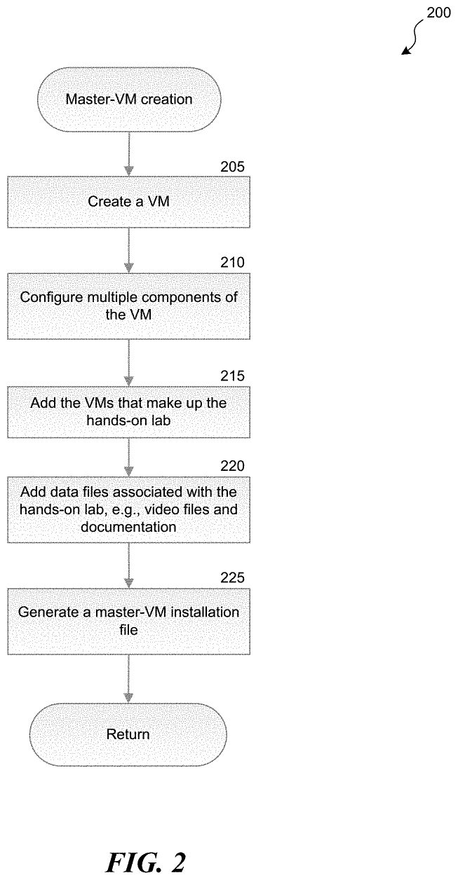

The application building component 110 can be used to build a hands-on lab for a specified application. In some embodiments, a hands-on lab is a collection of VMs, served by virtual storage, backed by virtual networking all integrated to teach the specified application. For example, the hands-on lab can include multiple VMs for Hadoop technology. The application building component 110 can also be used to prepare lab exercises, documents, which can be reference materials for doing the lab exercises, and training videos, which can be a collection of recorded video training lessons that explain how to do the lab exercises. Additional details with respect to creating the hands-on lab are discussed in detail at least with reference to FIG. 2 below.

The Master-VM building component 115 can be used to create a Master-VM 145. In some embodiments, the Master-VM 145 is a single VM that is capable of deploying a hands-on lab for teaching the specified application of the user's choice. The Master-VM 145 can include the hands-on lab for the specified application, a custom installer application that is capable of installing hypervisor software on the host server device 150 and then installing the hands-on lab on top of the hypervisor software.

The Master-VM building component 115 can bundle the hands-on lab, the custom installer all the required training materials for guidance, e.g., lab exercises, video lessons and reference documents into a single file, e.g., Master-VM installation file 135. In some embodiments, the Master-VM installation file is of the open virtualization format (OVA).

The Master-VM installation file 135 can be distributed to users in multiple ways. For example, a user can download the Master-VM installation file 135 from a server computing device, e.g., which can store Master-VM installation files for different hands-on labs, to the client device 130. In another example, the user can place an online order in an online store, e.g., associated with a service provider that provides various hands-on labs. The user can log into the online store and place an order for their desired hands-on lab, and have the Master-VM installation file 135 delivered to the user by mail in a storage device, e.g., a flash drive.

The VM provisioning component 120 can be used to deploy the Master-VM 145 at the client device, hypervisor software and the VMs associated with the hands-on lab on the host server device 150. A user can obtain the Master-VM installation file 135 using one of the multiple ways described above and import the Master-VM installation file 135 into the client device 130 and install the Master-VM 145 from the Master-VM installation file 135. After the Master-VM 145 is installed at the client device 130, the VM provisioning component 120 can install the hypervisor software and the multiple VMs associated with the hands-on lab on the host server device 150, e.g., using the installer application packaged in the Master-VM 145, that is connected to the client device 130. Additional details with respect to installation of the Master-VM is described at least with reference to FIG. 2.

The user can access the hands-on lab installed at the host server device 150 and the training materials associated with the hands-on lab using the client device 130, e.g., using a web browser application at the client device 130. For example, the user can access a specific uniform resource locator (URL) or an Internet Protocol (IP) address, to access the Master-VM 145 executing on the client device 130. The application access component 125 can then generate a graphical user interface (GUI) which lists the training materials of the hands-on lab, such as the lab exercises, videos, documentation is stored at the client device 130. The user can follow the step-by-step video lessons and lab exercises provided by the Master-VM 145 that teaches and guides the user in learning what is specifically built into the hands-on lab. The user can request to access the hands-on lab from the GUI at which point the application access component 125 can route the request to the VMs associated with the hands-on lab executing at the host server device 150.

The host server device 150 can be of any form factor or hardware configuration that is capable of running multiple VMs. As an example, the host server device 150 can include a server-grade processor, at least 32 GB RAM, a persistent storage device with at least 500 GB storage space, and at least one network interface. As another example, the host server device 150 can be a portable server device. The portable server device can have an integrated output device such as a liquid crystal display (LCD) screen, and a custom keypad with less keys than the normal keyboard, e.g., 5 keys in it.

In some embodiments, the client device 130 can be any computing device that is capable of executing a VM, such as a laptop, a desktop, a smartphone, or a tablet PC. The client device 130 and the host server device 150 can be connected to each other wirelessly or by wired means, e.g., an Ethernet crossover cable. The client device 130 also has the capability to connect with a communication network, e.g., local area network (LAN), wide area network (WAN), or Internet.

FIG. 2 is a flow diagram of a process 200 for creating a Master-VM for a hands-on lab of a specified application, consistent with various embodiments. The process 200 can be implemented in the environment 100 of FIG. 1. In some embodiments, building the “self-directed learning platform” includes the creation and customization of the Master-VM. It is this VM that will be delivered to the user from which the user can learn the desired products/technologies.

At block 205, the master-VM building component 115 creates a VM (referred to as Master-VM).

At block 210, the master-VM building component 115 configures various components of the Master-VM. In some embodiments, configuring multiple components includes installing and/or configuring various components of the VM. For example, the master-VM building component 115 configures the VM by installing an operating system, e.g., CentOS Linux. In another example, the master-VM building component 115 configures the VM by installing software packages, such as one or more of Trivial File Transfer Protocol (TFTP) server, Dynamic Host Configuration Protocol (DHCP) server, PHP packages, Python packages, Apache web server, NGINX (engine x) server, MariaDB, database server, Shellinabox package, Wordpress and other plugins.

In some embodiments, the master-VM building component 115 copies a custom installer application into the Master-VM 145. The custom installer application can facilitate installing hypervisor software and hands-on lab VMs in the host server device 150.

The master-VM building component 115 customizes the TFTP server so that Master-VM 145 can be the Preboot eXecution Environment (PXE) server to serve all the required files from the custom installer application.

The master-VM building component 115 customizes the DHCP server to serve dynamic IP addresses as a DHCP service may be needed as part of the PXE server setup.

At block 215, the master-VM building component 115 adds the multiple VMs that are associated with the hands-on lab of the specified application to the Master-VM 145. In some embodiments, the VMs that that make up the hands-on lab are in OVA format.

At block 220, the master-VM building component 115 adds the training materials associated with the hands-on lab, e.g., data files such as video lessons, documentation, lab exercises, to the master-VM 145. In some embodiments, the data files are copied under the document root of the NGINX server.

Further, the master-VM building component 115 configures the TFTP server to point to a directory where the multiple VMs associated with the hands-on lab reside. The master-VM building component 115 can configure Wordpress software under the document root of Apache web server. In some embodiments, Wordpress is used for content management and to serve all the training materials to the user through the Apache web server.

At block 225, the master-VM building component 115 exports the Master-VM 145 into an Master-VM installation file 135, e.g., OVA file. The Master-VM installation file 135 includes the Master-VM 145, which includes the multiple VMs associated with the hands-on lab, training materials for the hands-on lab and the installer application. The Master-VM installation file 135 is the file that can be distributed to the users, using which the users can access the hands-on lab on their corresponding host server devices.

Referring back to block 215, the multiple VMs that correspond to the hands-on lab are created by one or more entities, e.g., subject matter experts for the specified application, using a specified methodology. For example, an entity, e.g., an organization or an individual, who would like to use/provide the hands-on lab, may have a set of installation procedures, targeted use cases, methods in which they try to address the problem, may provide design guidelines and best practices to follow while customizing and using their products for the real world. Such factors are considered while designing the hands-on lab. Further, a hands-on lab can be of at least two types—a foundation hands-on lab or an integrated hands-on lab. In some embodiments, a foundation hands-on lab is designed to teach one specific technology or a product and to showcase its capabilities. In some embodiments, an integrated hands-on lab is focused on teaching the integration points of multiple technologies or products and their use cases. The type of the hands-on lab is also considered in designing the hands-on lab.

In some embodiments, having the best practices guidelines as the baseline, various other factors are considered for designing the hands-on lab. For example, if the best practices guidelines recommend 3 VMs for the role of a Master in its architecture to provide high-availability, then the application building component 110 is configured to provision at least 3 VMs as Master. Various parameters that may have to be considered in designing the hands-on lab include any of number of VMs; specifications of each VM with respect to processor, memory, storage and network interfaces; network details such as IP addresses, subnet masks, network topology; operating systems on each VM, a role of each VM (Server/Master or Client/Slave), and different software packages that have to be installed on different VMs based on their roles.

For example, the design specification for a hands-on lab for Hadoop technology can indicate that: 7 VMs to be installed, CentOS operating system to be installed in each of the VMs, each VM to be assigned a unique static IP address, different software packages to be installed on different VMs based on their roles (e.g., head node, secondary node, data nodes), multiple network segments to be created (WAN, LAN) with their own network address space (e.g., WAN: 10.1.1.X, and LAN:172.16.10.X), a gateway VM, e.g., EDGE, to be installed as the gateway between the two network segments, all VMs to be configured with EDGE as their gateway, and one specific VM to be designated to play the role of a Jumpbox in which when a request from a user is routed to the hands-on lab, the request is routed to the Jumpbox, which can then forward the request to other VMs as appropriate.

After the hands-on lab is built, the application building component 110 is configured to export all the individual VMs of the hands-on lab into separate VM files, e.g., OVA files. In some embodiments, these VM files are the ones which will be included in the Master-VM 145.

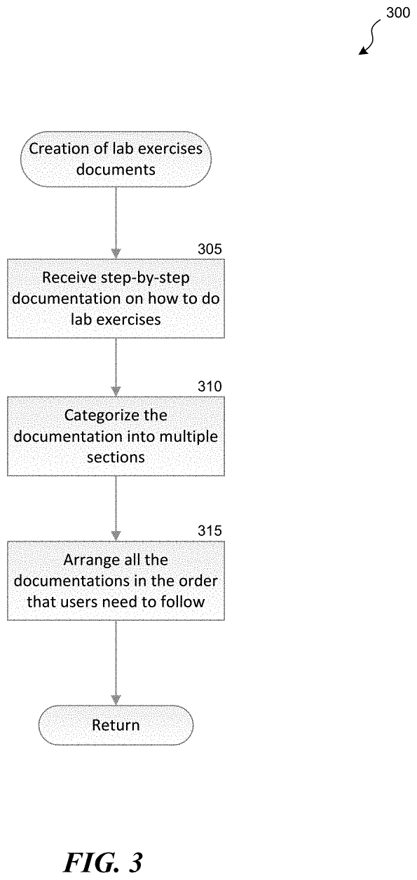

FIG. 3 is a flow diagram of a process 300 for creating lab exercises for a hands-on lab of a specified application, consistent with various embodiments. The process 300 can be implemented in the environment 100 of FIG. 1. In some embodiments, a hands-on lab is logically grouped into multiple stages so that the user can decide as which would be the starting point on learning the technology or product built in the hands-on lab. These stages are as follows: (a) barebones stage, (b) semi-configured stage, (c) half-configured stage, (d) full-configured stage, (e) full-configured+Demo stage, and (f) clone-the-lab stage.

In some embodiments, in the barebones stage, none of the VMs of the hands-on lab is configured with the individual software needed based on its role. The user is expected to configure the individual software as part of the lab exercises.

In some embodiments, in the semi configured stage, some of the VMs are configured, e.g., VMs whose role is “master”, but the rest of them, e.g., VMs whose role is “slave”, may be left un-configured for the user to complete.

In some embodiments, in the half-configured stage, half of the configurations with regards to the VM are pre-built, e.g., performed automatically by the application building component 110, and the rest is left un-configured for the user to complete.

In some embodiments, in the full-configured stage, the entire hands-on lab may be fully configured with all the required use cases. For instance, if the hands-on lab is being built for running an ecommerce website, the fully configured hands-on lab could have the components required to build the e-commerce website and also be configured to interact with various components as a specified use case may demand. For example, for the e-commerce website, the fully configured hands-on lab can have a web server, a database server, frontend components to generate the e-commerce website and/or receive input from a user of the website to perform a particular action. The fully configured hands-on lab can also configure each of the components to interact with one another in a specified way to perform a particular use case, e.g., generating a catalog of items available for sale in the e-commerce website.

In some embodiments, in the “full-configured+demo” stage, the entire hands-on lab may be fully configured, e.g., as described above, and also include all the required use cases, e.g., demos and proofs-of-concept (POCs). In some embodiments, sales-engineers can just use the hands-on lab straight out of the box to showcase the demos and POCs to their potential and targeted customers without having to spend their time in building the POCs and/or demos. Continuing with the above example of the e-commerce website, the “full-configured+demo” hands-on lab can provide a fully configured hands-on lab for the e-commerce website and a demo of actions to be performed for configuring the hands-on lab to generate a catalog of items available for sale in the e-commerce website.

In some embodiments, the clone-the-lab stage option is provided to the user for backing up or cloning a hands-on lab executing at a server device to a storage device, e.g., a flash drive. That way, the lab exercises the user has completed so far can be preserved, and used at a later time to continue from where the user had previously stopped.

Referring back to the process 300, at block 305, the application building component 110 is configured to receive information on how to do a lab exercise, e.g., from an entity such as a subject matter expert for which the hands-on lab is being created. The information can include step-by-step documentation that will guide the user on how to perform the lab exercise. The application building component 110 can generate the documentation based on the received information.

At block 310, the application building component 110 is configured to receive information about various sections of the documentation. For example, performing a lab exercise may be categorized into various sections, and the application building component 110 is configured to categorize the documentation into multiple sections, and generate the documentation for each section accordingly.

At block 315, the application building component 110 is configured to arrange the document in an appropriate sequence, e.g., as the sequence of steps to be followed is important for performing the lab exercise.

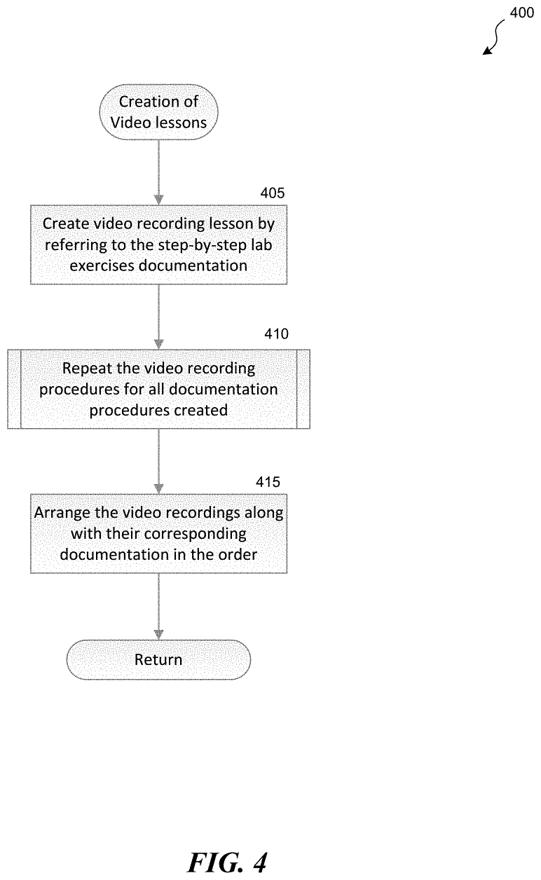

FIG. 4 is a flow diagram of a process 400 for creating video lessons for a hands-on lab of a specified application, consistent with various embodiments. The process 400 can be implemented in the environment 100 of FIG. 1. In some embodiments, while the step-by-step documentation help a user in performing the lab exercises, a video lesson a much effective way of learning is by following the recorded video lessons and continue doing the lab exercises side-by-side.

At block 405, a video lesson for guiding the user to perform a lab exercise is created. In some embodiments, the video lesson refers to the step-by-step documentations that were created in the process 300 of FIG. 3. The video lesson can be created using one of multiple available video recording software. In some embodiments, the video lesson is recorded while an entity, e.g., a subject matter expert, is doing the lab exercise. The video lessons can be created as small video recordings so that they will be much easier for users to follow.

At block 410, the process 400 determines whether all video lessons are created, e.g., for all documentation procedures created in the process 300. If all the video recordings are completed, the process 400 proceeds to block 415, else the control is transferred to block 405.

At block 415, once all video recordings are completed, the videos are arranged in the same order as the step-by-step documentation that were used as reference.

After the Master-VM installation file 135 is created, the distribution of the Master-VM installation can be done through various channels, e.g., as described at least with reference to FIG. 1. For example, a user can sign up with an online store that provides hands-on labs for various applications. The user can navigate the online catalog and place the order for the desired Hands-on lab. After the order is successfully placed, the Master-VM installation file 135 corresponding to the selected hands-on lab can be downloaded to a user device, e.g., the client device 130, or can be delivered via mail on a storage device, e.g., a flash drive.

In some embodiments, the user can select the language of choice in which the user would like to learn and obtain the Master-VM installation file 135 for the corresponding language. A selected list of languages will be given for each hands-on lab.

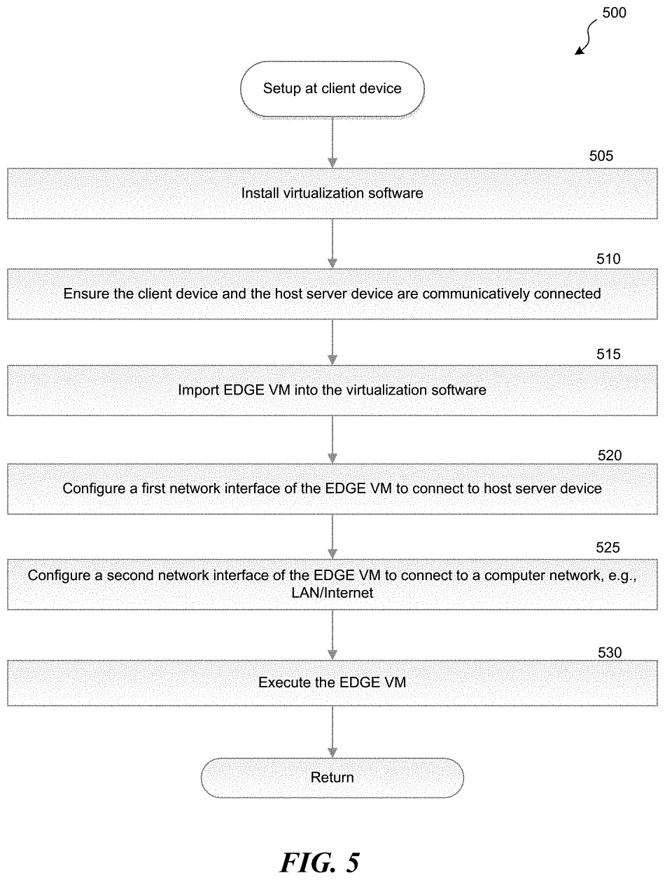

FIG. 5 is a flow diagram of a process 500 for configuring a client device to install a Master-VM, consistent with various embodiments. In some embodiments, the process 500 can be implemented in the environment 100 of FIG. 1. After obtaining the Master-VM installation file 135, e.g., as described above, the user can install the Master-VM 145 at a user device, e.g., the client device 130. The Master-VM 145 at the client device 130 can then install the hands-on lab at a server device, e.g., the host server device 150, which the user can access using the Master-VM 145. In some embodiments, the user may have to configure the client device 130 prior to using the Master-VM 145 for creating the hands-on lab.

At block 505, a virtualization software, such as VirtualBox or VMware Fusion software, is installed at the client device 130. In some embodiments, the virtualization software or a hypervisor is a software that creates and/or runs a VM. The virtualization software is installed on the client device 130 to run the Master-VM 145.

At block 510, establish a communication network between the client device 130 and the host server device 150. The communication network can be established wirelessly or using wired means, e.g., Ethernet crossover cable.

At block 515, an EDGE VM is imported into the virtualization software. The EDGE VM can act as a gateway between two different communication networks. In some embodiments, the EDGE VM can be provided with the Master-VM installation file 135, e.g., on the same storage device, such as a USB drive containing the Master-VM installation file 135 that is shipped to the user.

At block 520, a first network interface of the EDGE VM is configured to connect to the host server device 150. In some embodiments, two different network segments are created on the client device 130, e.g., “LAN” and “CROSSOVER” network. For example, one network interface of the client device 130, e.g., on the client device 130 side of the crossover cable, can be configured with a Static IP address, e.g., “10.1.1.100” and a subnet mask, e.g., “255.255.255.0” and named as “CROSSOVER.” A second network interface of the client device 130 can be configured as an uplink network, e.g., a network that allows communication with an external network such as LAN or Internet. The second network interface can be configured with either a DHCP or static IP address that is based on the LAN where the client device 130 is being used or connected, and this network can be named as “LAN.”

The first network interface of the EDGE VM is configured to connect to the host server device 150 by connecting to the network named “CROSSOVER.”

At block 525, a second network interface—of the EDGE VM is configured to connect to an external network, e.g., LAN or Internet. The second network interface of the EDGE VM is configured to connect to the external network by connecting the EDGE VM to the network named “LAN.”

At block 530, the EDGE VM is executed. In some embodiments, the EDGE VM is executed by powering on the EDGE VM. After the EDGE VM completes its boot sequence, the EDGE VM is considered to be executing.

After the above configuration setup is completed, the Master-VM 145 can be imported into the virtualization software and executed.

Referring back to block 515, in some embodiments, apart from having the Master-VM installation file 135 and the EDGE VM on the USB drive, one or both of them can be stored at the host server device 150 after the hands-on lab is installed, which can serve multiple purposes. First, it can eliminate the need for the user to carry the USB drive with them. Second, instead of importing them from the USB drive, the same VMs can be downloaded directly from the host server device 150 onto the client device 130. In embodiments where the Master-VM installation file 135 and the EDGE VM server are stored at the host server device 150, the redeployment of Master-VM 145 and the EDGE-VM from the host server device 150 onto the client device 130 (or any device that does not yet have the Master-VM 145 and the EDGE VM), can be automated using one or more scripts, which are software programs configured to perform a specific activity.

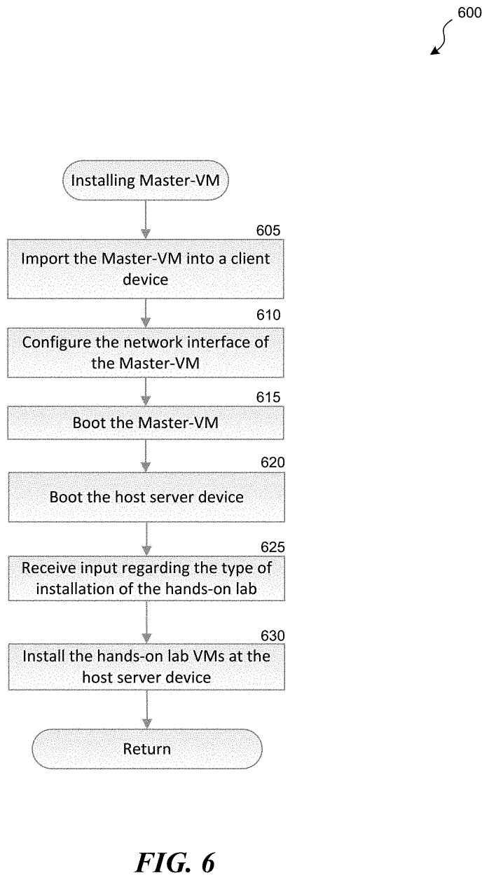

FIG. 6 is a flow diagram of a process 600 for installing a Master-VM at a client device, consistent with various embodiments. In some embodiments, the process 600 can be implemented in the environment 100 of FIG. 1. After the client device 130 is configured to install the Master-VM 145, e.g., as described at least with reference to process 500 of FIG. 5, the Master-VM 145 can be installed at the client device 130.

At block 605, the Master-VM installation file 135 is imported into the client device 130, e.g. from the USB drive having the Master-VM installation file that is shipped to the user.

At block 610, the network interface of the Master-VM 145 is configured to the external network, e.g., by connecting the Master-VM 145 to the network named “CROSSOVER” created in the process 500.

At block 615, the VM provisioning component 120 installs the Master-VM 145 in the virtualization software, e.g., in response to powering on the Master-VM 145. After the boot-up sequence of the Master-VM 14 completes successfully, the Master-VM 145 is considered to be executing at the client device 130.

At block 620, a network boot is performed at the host server device 150. In some embodiments, the host server device 150 is also connected to the “CROSSOVER” network.

At block 625, the VM provisioning component 120 receives an input from the user of the client device 130 regarding a type of installation of the hands-on lab. In some embodiments, after the host server device 150 completes the boot up sequence, a menu having options for multiple installation types of the hands-on lab may be provided. In some embodiments, the multiple installation types include barebones, semi-configured, half-configured, full-configured, and clone-lab. The user may select one of the installation types.

At block 630, the Master-VM 145 provisions all the VMs of the hands-on lab, e.g., the VMs that were bundled with the Master-VM 145 in the process 200 of FIG. 2, onto the host server device 150 based on the installation type. The VMs are provisioned onto the host server device 150 through the CROSSOVER network. In some embodiments, a hypervisor and the EDGE VM are also provisioned onto the host server device 150 with the VMs of the hands-on lab. Further, all necessary configurations, e.g., network configurations, are also performed by the Master-VM 145 at the host server device 150.

After all the VMs are provisioned, the user can access the hands-on lab and/or the training materials associated with the hands-on lab from the Master-VM 145 on the client device 130.

In some embodiments, instead of connecting the USB drive to the client device 130, it can be connected directly to the host server device 150. The USB drive is capable of booting the host server device 150. After the host server device 150 boots, the hypervisor and all the virtual machines those are part of the hands-on lab can get deployed directly from the USB drive. In some embodiments, such a method eliminates the dependency of having the client device 130 as a Boot/PXE server but boots the host server device 150 directly from the USB drive.

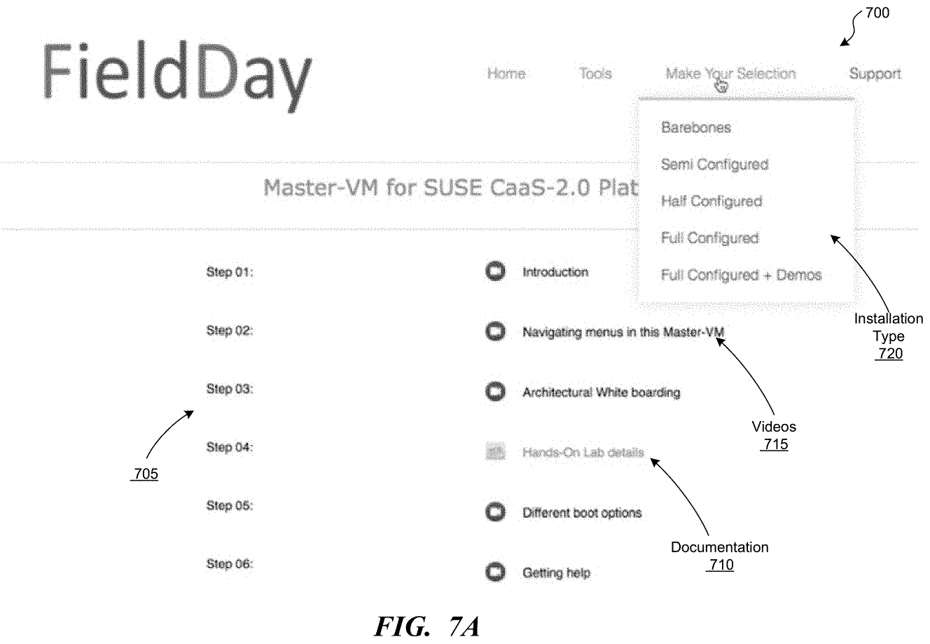

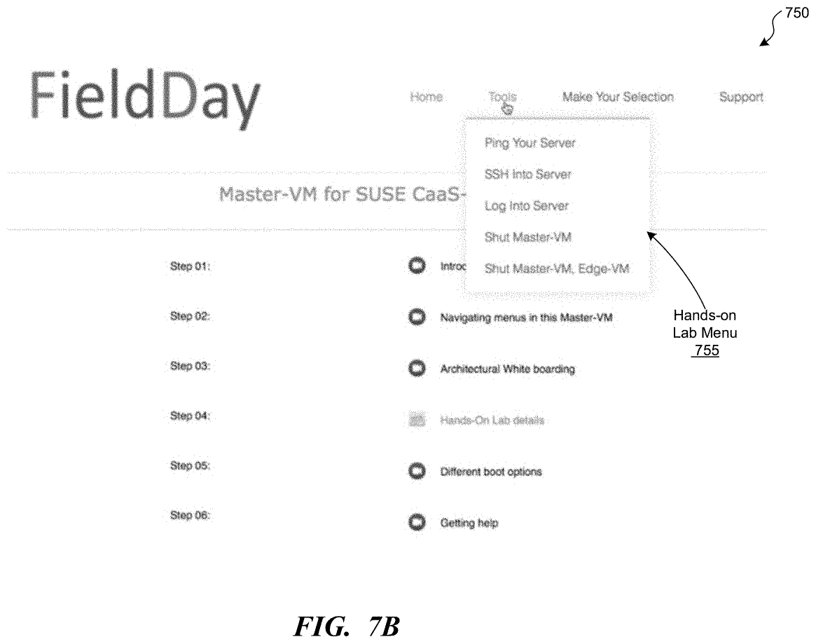

FIG. 7A is an example screenshot 700 of a homepage of the Master-VM, consistent with various embodiments. In some embodiments, the user can access the Master-VM 145 on the client device 130, e.g., using a web browser application. The user may access the homepage of the Master-VM 145 at a configured Uniform Resource Locator (URL) or an IP address. The homepage of the Master-VM 145 can provide access to all the video lessons 715 and documentations 710 for various steps 705 of the lab exercises. The homepage also provides installation type menu 720 to choose a specified installation type of the hands-on lab.

FIG. 7B is another example screenshot 750 of a homepage of the Master-VM, consistent with various embodiments. The homepage of the Master-VM 145 can also provide a hands-on lab menu 755 to access the hands-on lab. When the user logs into the hands-on lab at the host server device 150, the user is directed to a console of a Jumpbox VM, e.g., one of the hands-on lab VMs. In some embodiments, the Jumpbox VM would be a location where a request from the user for performing the lab exercises is routed to by the Master-VM 145. The Jumpbox VM can further route the request to an appropriate VM in the hands-on lab.

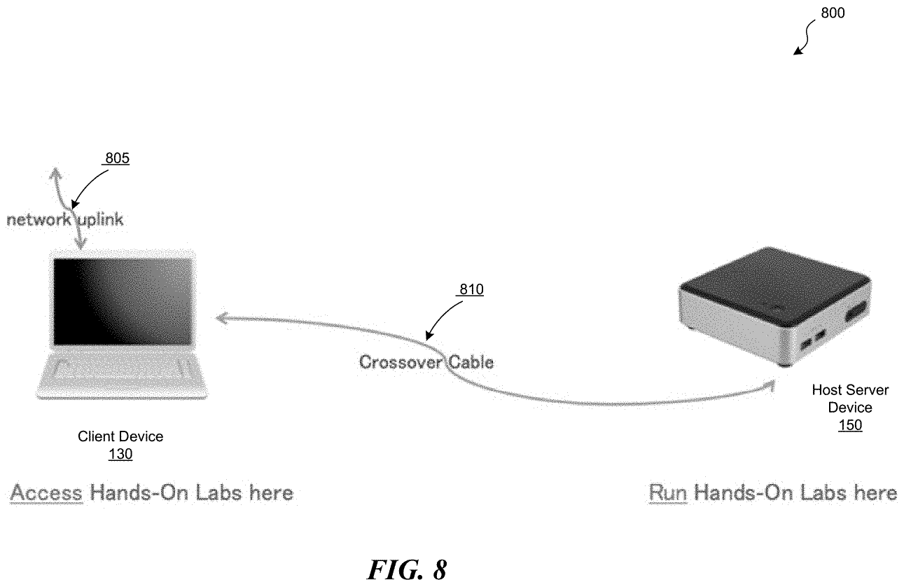

FIG. 8 is a block diagram of the environment 800 in which the disclosed embodiments can be implemented. In some embodiments, the environment 800 is similar to the environment 100 of FIG. 1. The environment 800 includes the client device 130 on which the Master-VM 145 is installed and accessed from, and the host server device 150 at which the VMs of the hands-on lab are provisioned and accessed through the Master-VM 145 at the client device 130. The client device 130 and the host server device 150 are connected to each other via crossover cable 810. In some embodiments, the client device 130 and the host server device 150 can be connected to each wirelessly. The client device 130 is further configured with a network interface 805 to have access to an external network, e.g., LAN or Internet.

In some embodiments, the client device 130 can be any computing device that is capable of executing a VM, such as a laptop, a desktop, a smartphone, or a tablet PC.

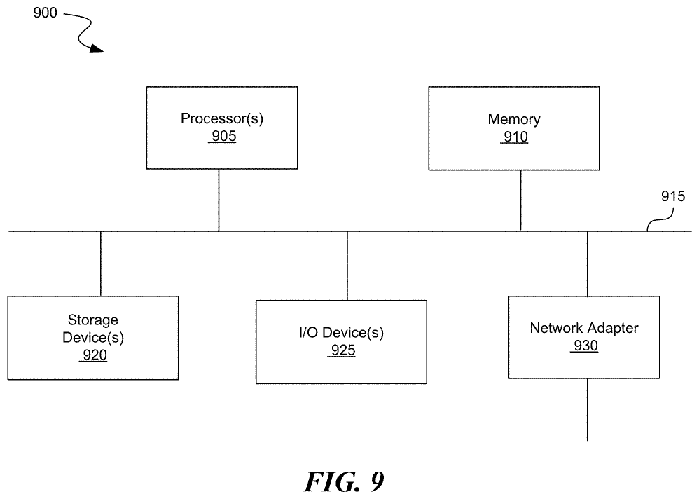

FIG. 9 is a block diagram of a computer system as may be used to implement features of the disclosed embodiments. The computing system 900 may be used to implement any of the entities, components or services depicted in the examples of the foregoing figures (and any other components described in this specification). The computing system 900 may include one or more central processing units (“processors”) 905, memory 910, input/output devices 925 (e.g., keyboard and pointing devices, display devices), storage devices 920 (e.g., disk drives), and network adapters 930 (e.g., network interfaces) that are connected to an interconnect 915. The interconnect 915 is illustrated as an abstraction that represents any one or more separate physical buses, point to point connections, or both connected by appropriate bridges, adapters, or controllers. The interconnect 915, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 910 and storage devices 920 are computer-readable storage media that may store instructions that implement at least portions of the described embodiments. In addition, the data structures and message structures may be stored or transmitted via a data transmission medium, such as a signal on a communications link. Various communications links may be used, such as the Internet, a local area network, a wide area network, or a point-to-point dial-up connection. Thus, computer readable media can include computer-readable storage media (e.g., “non-transitory” media) and computer-readable transmission media.

The instructions stored in memory 910 can be implemented as software and/or firmware to program the processor(s) 905 to carry out actions described above. In some embodiments, such software or firmware may be initially provided to the processing system 900 by downloading it from a remote system through the computing system 900 (e.g., via network adapter 930).

The embodiments introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

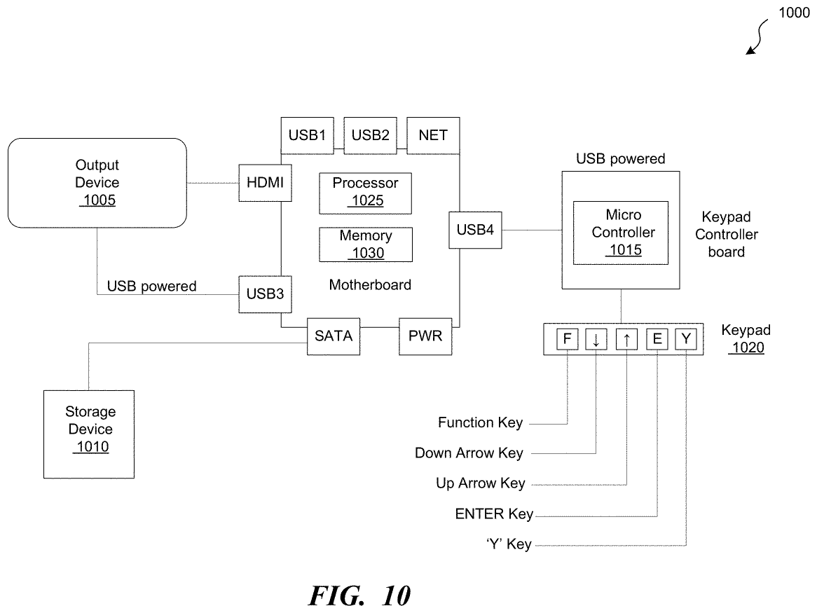

FIG. 10 is a block diagram of a computing system 1000 for implementing the host server device 150 of FIG. 1, consistent with various embodiments. While the host server device 150 can be implemented using the computing system 900 of FIG. 9, it can also be implemented using the computing system 1000. The output device 1005 can be a built-in and integrated LCD screen, and can be connected to a variety of display interfaces, e.g., high-definition multimedia interface (HDMI). The processor 1025 can be a server grade processor. The memory 1030 can be used to store instructions that need to executed by the processor 1025 to implement the disclosed embodiments. One example configuration of the memory can include 32 GB RAM. The storage device 1010 can be used to store the VMs and other necessary software for executing the hands-on lab installed on the host server device 150. One example of the storage device 1010 can include a solid state drive (SSD), which can be connected to the motherboard via various interface, e.g., Serial AT Attachment (SATA) interface.

The motherboard can include various hardware ports, e.g., one or more Universal Serial Bus (USB) ports and a network port such as Ethernet port. The Ethernet port can be used to connect the host server device 150 with other devices, e.g., the client device 130, using wired means, e.g., the crossover cable 810 of FIG. 8.

The keypad 1020 can be mini keypad, which is smaller in size and has lesser number of keys than a typical keyboard. In some embodiments, the keypad 1020 include only 5 input keys to manage and use the host server device 150. The functions of 5 keys on the keypad can be as follows: Key-01 programmed as Function Key F10, Key-02 programmed as down arrow key, Key-03 programmed as up arrow key, Key-04 programmed as Return/Enter key, and Key-05 programmed as alphabet “Y,” which indicates a “Yes.” Such a miniature design of the keypad 1020 can eliminate a need for an external monitor or a keyboard. The above keys are custom designed in such a way that these 5 keys would be sufficient to install any of the hands-on labs that are designed and built to execute on the host server device 150.

The keypad 1020 is connected to the motherboard via a microcontroller 1015 installed on a keypad controller board that is designed specifically for the computing system 1000. The keypad controller board, and therefore the microcontroller 1015 is connected and powered on by one of the USB ports on the motherboard.

The keypad 1020 senses the keys that are pressed and sends information to the microcontroller 1015, which communicates the key status over USB to the motherboard. When a key is pressed, the keypad 1020 sends a low voltage to a General-purpose input/output (GPIO) port of the microcontroller 1015, which is held high by default. In some embodiments, debouncing of the key presses can be performed in software. The keypad 1020 can also have a push-button switch for powering the computing system 1000.

In some embodiments, a touch screen can be used instead of or in addition to the keypad 1020. While the LCD screen can provide all the details with regards to the hands-on lab, the touch screen can act as an input device for the user to interact with the host server device 150. This would be of great ease of use and can provide a superior user experience, and can also save some real estate space on the host server device 150.

The Master-VM framework 105 can be implemented in a hybrid cloud environment, e.g., where workloads can run and interoperate seamlessly on both a private cloud and a public cloud. In some embodiments, the Master-VM framework 105 can provision all the necessary software components of the private cloud (pertaining to those specific use cases) on the host server device 150 quickly, with a single Master-VM 145. This Master-VM 145 can then be distributed to anyone so that they can re-create the private cloud environment on one's own host server device 150, thereby eliminating the cost and complexity in building an environment that is needed for training and learning purposes.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described, which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

I/We claim:

1. A computer-implemented method, comprising:
generating a master-virtual machine (VM) installation file for installing a master-VM on a client device;
adding an application package to the master-VM installation file, wherein the application package includes a collection of VMs corresponding to an application, wherein a first VM of the collection is different from a second VM of the collection, and wherein at least one VM of the collection has a first role and another VM of the collection has a second role;
adding, to the master-VM installation file, data files that provide information regarding the application;
configuring multiple components of the master-VM to install the collection of VMs at a host server device and provide access to the data files;
adding an installer application to the master-VM installation file that is configured to install hypervisor application at the host server device;
installing, using the master-VM installation file, the master-VM at the client device;
installing, from the client device and by the master-VM, the collection of VMs in the master-VM installation file at the host server device;
receiving, at the client device, a user request to access the application at the host server device; and
providing access to the application at the host server device via the master-VM at the client device.

2. The computer-implemented method of claim 1 further comprising:
storing the master-VM installation file at the host server device or the client device.

3. The computer-implemented method of claim 1 further comprising:
generating, at the client device, information regarding the data files stored at the client device, the data files including multimedia content having information regarding accessing or configuring the application;
receiving, at the master-VM and by a user, a request to access one or more of the data files; and
providing, by the master-VM, access to the data files to the user.

4. The computer-implemented method of claim 1 further comprising:
receiving, at the master-VM and by a user, a request to access the collection of VMs; and
providing, by the master-VM, access to the collection of VMs.

5. The computer-implemented method of claim 1, wherein installing the collection of VMs includes:
installing, by the master-VM and using the installer application, a first hypervisor software at the host server device.

6. The computer-implemented method of claim 1, wherein installing the master-VM includes:
installing a second hypervisor software at the client device.

7. The computer-implemented method of claim 1 further comprising:
installing an edge VM gateway at the host server device and the client device.

8. The computer-implemented method of claim 7, wherein the master-VM and any VM of the collection of VMs communicate with each other via the edge VM gateway.

9. The computer-implemented method of claim 7, wherein installing the master-VM includes:
configuring a first network interface of the edge VM gateway at the client device to communicate with the edge VM gateway at the host server device, and
configuring a second network interface of the edge VM gateway at the client device to communicate with a computer network.

10. The computer-implemented method of claim 1, wherein installing the collection of VMs includes:
generating information regarding multiple types of installation of the collection of VMs, each type of installation specifying a type of configuration to performed for the collection of the VMs,
receiving, from the user, a specified type of the multiple types as an input, and
configuring the collection of the VMs based on the specified type.

11. The computer-implemented method of claim 10, wherein the multiple types include:
a first type of installation, which indicates that none of the VMs in the collection of VMs are to be configured by the master-VM,
a second type of installation, which indicates that at least some of the VMs in the collection of VMs are to be configured by the master-VM, and
a third type of installation, which indicates that all of the VMs in the collection of VMs are to be configured by the master-VM.

12. The computer-implemented method of claim 10, wherein the multiple types include:
a fourth type of installation, which indicates that the collection of VMs at the host server device are to be copied to another storage device.

13. The computer-implemented method of claim 1, wherein adding the application package includes:
determining configuration information associated with the collection of VMs, wherein the configuration information includes at least one of a number of VMs to be required for the application, hardware specification for each VM, an operating system to be installed on each VM, a role of each VM, wherein the role is one of a master role or a slave role.

14. A computer-readable storage medium storing computer-readable instructions, comprising:
instructions for generating a master-virtual machine (VM) installation file for installing a master-VM on a client device;
instructions for adding to the master-VM installation file, (a) an application package, wherein the application package includes a collection of VMs corresponding to an application, and (b) data files that provide information regarding the application;
instructions for configuring multiple components of the master-VM to install the collection of VMs at a host server device and provide access to the data files;
instructions for installing, using the master-VM installation file, the master-VM at the client device; and
instructions for installing, by the master-VM, the collection of VMs in the master-VM installation file at the host server device.

15. The computer-readable storage medium of claim 14 further comprising:
instructions for receiving, at the master-VM and by a user, a request to access one or more of the data files, the data files including multimedia content having information regarding accessing or configuring the application;
instructions for providing, by the master-VM, access to the data files to the user;
instructions for receiving, at the master-VM and by a user, a request to access the collection of VMs; and
instructions for providing, by the master-VM, access to the collection of VMs.

16. A system, comprising:
a processor; and
a memory comprising instructions which, when executed, perform a method of:
installing a master-virtual machine (VM) at a client device, wherein the master-VM includes (a) an application package having a collection of VMs corresponding to an application, wherein a first VM of the collection is different from a second VM of the collection, and wherein at least one VM of the collection has a first role and another VM of the collection has a second role, and (b) data files that provide information regarding the application;
configuring a host server device to host the collection of VMs, wherein the first component is configured to install the collection of VMs included in the master-VM at the host server device;
receiving, from a user and at the master-VM, a request to access one or more of the data files;
providing, by the master-VM, access to the data files to the user stored at the client device;
receiving, by the user and at the master-VM on the client device, a request to access the collection of VMs at the host server device; and
providing, by the master-VM, access to the collection of VMs at the host server device via the master-VM at the client device.

17. The system of claim 16, wherein the host server device is connected to the client device via a crossover cable or a wireless network.

18. The system of claim 16, wherein the host server device includes an integrated custom keyboard, the custom keyboard communicating keystrokes to a processor of the host server device via a microcontroller.
